(19) United States
(12) Patent Application Publication
(10) Pub. No.: US 2026/0210985 A1
(43) Pub. Date: Jul. 23, 2026

(54) SUBSTANCE PREPARATION METHOD OF CAPSULES AND SYSTEM

(71) Applicant: ECOLE POLYTECHNIQUE FEDERALE DE LAUSANNE (EPFL), Lausanne (CH)

(72) Inventors: Edy MARIANO, MORGES (CH); Pascal MIEVILLE, GENEVE (CH); Florian DE NANTEUIL, GENEVE (CH); Marc KUNZE, CHAVORNAY (CH)

(21) Appl. No.: 19/140,951

(22) PCT Filed: Dec. 14, 2023
(86) PCT No.: PCT/IB2023/062678

§ 371 Date: Jun. 18, 2025

(30) Foreign Application Priority Data
Dec. 22, 2022 (EP) 22215745.5

(51) Int. Cl. G01N 35/00

(52) U.S. Cl. CPC G01N 35/0099; G01N 2035/00188; G01N 2035/00465

(57) ABSTRACT

The present invention concerns an automated substance preparation method comprising:—providing a first substance container containing a first substance;—a step of sampling to extract at least one portion of the first substance;—determination of a mass of the extracted at least one portion of the first substance;—encapsulating, in a first capsule, the extracted at least one portion of the first substance; and—repeating the step of sampling, mass determination and encapsulating to form a plurality of first capsules of the first substance having randomly distributed different masses of the first substance.

### FIELD OF THE INVENTION

The present invention relates to a method and system for preparing substances, for example, for preparing encapsulated powders and for combining or associating these prepared substances for use in an experiment or operation involving mixing or reacting of these substances.

The present invention in particular relates to preparation of encapsulated substances by substance sampling without targeting a specific or standard substance mass for encapsulation. The prepared encapsulated substances may, for example, be inventoried and stored to provide a substance mass distribution distributed across a range of substance masses. The prepared encapsulated substances may, for example, also be retrieved from storage in a capsule combination permitting an envisaged experiment or operation involving mixing or reacting of the substances and release of the substances to carrying out the experiment or operation. The method and system may be a robotized method and system.

### BACKGROUND

Predictive models have become reliable in various fields of science due to the parallel development of highly efficient algorithms with the availability of large, structured databases. In the field of chemistry, however, progress has been slow due mostly to the lack of available data. The reason for this relies mostly on the fact that chemistry is performed by humans and experimental conditions are reported under non machine-exploitable formats. There is therefore a big gap to close in order to bring synthetic chemistry to a level where prediction algorithms are used routinely and trustfully. Generating and collecting large amounts of high quality and reliable data will be necessary.

Automation may be a way to capture holistically experimental conditions of an experiment and to report them in a standardized way. In synthetic chemistry, automation has seen some major development in recent years with the improved availability of robotic systems: prices are lower and their programming is simpler. However, to collect sufficient data to feed algorithms, processes will have to be performed at high throughput.

Modern automation platforms have been developed in some areas of chemistry such as synthesis, material science, pharmaceuticals or catalysis. Nowadays, almost all chemical processes will require catalysis for performance and sustainability. As a highlight of its importance, the 2021 Nobel Prize in chemistry was awarded to two researchers in the field of green catalysis. The fast development of new catalysts or catalytic processes relies strongly on the capacity to handle quickly and precisely small quantities of expensive, hard-to-access organometallic species under confined atmosphere. Automation could also play an important role to accelerate the discovery of new catalysts, however, so far, only tools designed for specific applications have been developed.

Contrary to liquids whose behavior can be generalized, powders are complicated to handle. Because of their physico-chemical properties, liquids will adjust to the shape of its container, fill the space homogeneously and are not compressible. Density can be exploited to evaluate mass transfers using the volume and vice versa. While they can be characterized using analytical tools, powder behaviors will greatly depend on their crystalline structure and consequently, even a similar compound can have different physical behaviors. Additionally, other phenomenon arising at the molecular level can increase the complexity of powder handling. For example, conductivity will influence the electrostatic charge of a powder which can greatly disturb its precise handling. Some powders are hygroscopic and will absorb water rapidly and modify its composition and behavior. Finally, other factors such as porosity, compactibility, flowability increase the complexity of the problem when aiming at the precise handling of small quantities of powders.

In many industries (for example, petrochemistry, mining, cement, food), it is necessary to be able to handle and transfer powders. However, because of the reasons highlighted above, systems have been limited to large scale installation dedicated and engineered to one type of powder.

Applications such as high-throughput experimentation (HTE) have great potential to speed up the discovery cycle of new active compounds in the pharmaceutical, agrochemical or materials fields. In this context, some tools designed for specific applications have been developed but automation of the handling of small quantities of powders is very challenging. Existing tools aim at dispensing exact target masses which is a fight between the precision of the dispense and the time it takes to reach the exact target mass. Some robotic tools collect and dispense an exact amount of powder by iterations of a “collect & dispense” process which is very time consuming. Other robotic technologies use gravimetric dispense from a container placed above the target vial located on a balance. Performing small iterations of an “open & close” process, allows them to reach the desired mass. Because of their dispensing mode, it is very complicated for these systems to completely prevent cross contaminations between different samples. Powder can flow outside the target container in gravimetric systems and some residual powder can fall in other containers during the movement of the dispense containers above the platform. These technologies also require the presence of a minimum amount of solid to be able to collect the sample. In this case, the dead volume is not negligible and represents an issue for expensive substances or powders. Such cross contamination can have severe consequences on the quality of the experimental results. Added to this issue is the complex behavior of powders that prevent the use of a single tool for the handling of all types of powders.

Indeed, extracting powder is a very complex task. When a human is extracting powder, for example by coring using capillaries, they are simultaneously using their arms, eyes and brain. Some back and forth movement with the capillary will be performed, maybe even twisting it while coring or entering the powder at a certain angle. This will directly be seen by their eyes when the capillary is entering the powder (each vial may have a different amount of powder). It is also felt when the capillary is touching the bottom of the vial. Adaption will automatically be performed as a function of the powder characteristics. Humans adapt their movements (speed, force, ...) automatically as well as, for example, the number of coring as a function of the powder characteristics. Extracting powder is thus a very complex task involving agile and precise actions, feedback and adaptation. It is even more complex if very small quantities need to be handled.

Therefore, there is a need to greatly improve the efficiency of automated platforms in chemistry. There is a need for enhanced throughput chemical platforms and for an increased quality and quantity of experiments that can be run. There is a need to increase generation of high quality data that can later be exploited efficiently by predictive models. There is additionally a need to deal with the widely encountered problem of handling of powders and in particular small quantities of powders. This can hamper performing high throughput experimentation in particular when using valuable, hard-to-access chemicals. Crucial tasks are carried out more slowly and are currently done manually or take-up a large part of the experiment time. Additionally, the absence of high precision handling of powders can result in the collection of unreliable experimental data that is unsuited for the creation of prediction models by machine learning. There is also a need to develop processes when handling powders that are greener and more sustainable, for example, that generate less waste, that use sustainably sourced building blocks, and that can assure an improvement of process yield. The provision of high quality data that can later be exploited efficiently by predictive models can also assure the development of processes that are greener and more sustainable.

US8709361B2 discloses a method for carrying out a chemical reaction between a premetered amount of a first substance and a premetered amount of a second substance. The premetered amount of each substance is contained inside a sealed and air-tight container and each container contains a known absolute and exact amount of the substance specifically defined in nmol amount. A set of containers containing a substance is disclosed. A set of containers contain the same substance with a first container of the set having a quantity of x nmol of the substance and a second container having a quantity y.x/1000 nmol of the substance, where x and y are integers, and y can be from 1100 to 10000. Each container of the set of containers thus contains a known absolute and exact amount of the substance specifically defined in nmol amount.

### SUMMARY

It is therefore one aspect of the present disclosure to provide an automated substance preparation method according to claim 1 and an automated substance preparation system according to claim 23 that address the above-mentioned inconveniences and needs.

Specific embodiments and other advantageous features can be found in the dependent claims.

The automated substance preparation method and system of the present disclosure provides an innovative solution that allows a standardized handling of all kinds of powders at low scale and enables a full automation of chemical platforms. It allows the handling of small quantity of powders, assures or enhances high throughput, and increases the quality and quantity of experiments that can be carried out, generating datasets of high quality and quantity. This high quality data can be exploited by predictive models to assure the development of processes that are more environmentally friendly and more sustainable. The method and system can also assure a substance handling that is more environmentally friendly and more sustainable, for example, through reduced waste and improved yield.

The automated substance preparation method and system provides a global process permitting to sample rapidly and precisely sub-milligram amounts of powders, and addresses the time and precision constraints inherent to high throughput experimentation.

The automated substance preparation method and system assures stochastic robotized micro-sampling (StoRMS) of substance and powders. The method and system provides a great gain of resources for the preparation of an experiment. The sampling can be done ahead or in parallel of the experiments requiring powder. As the solids are encapsulated in standardized glass containers, the robotic dispense of capsules is very efficient, requires no iterative steps, and is not disturbed by the variations of powders properties. Additionally, it becomes possible to manipulate very small quantities of material (sub mg) efficiently, making this process very advantageous to work with valuable chemicals that can only be accessed in small amounts.

Precise handling of milligrams of powders is highly relevant in many industries, such as pharmaceuticals, pigments, agrochemicals, medicine, materials etc . . . The method and system allows to transfer small quantities of powders quickly and precisely and will be of great benefit to such industries.

The advantages of encapsulation of powders extends ahead of just solid dispensing. It will enable the efficient manipulation of the chemicals through an automated platform with little footprint. It will protect chemicals from light, oxygen and moisture that are known to accelerate their degradation during storage. It will also prevent cross contamination during the handling of powders by robots.

The method and system provide a very clean and efficient way to store powder samples that need to be kept under highly controlled conditions such as analytical standards or precious chemicals.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIGS. 1A and 1B show an exemplary automated substance preparation system according to the present disclosure.

FIG. 2A shows an exemplary automated substance preparation method according to the present disclosure.

FIG. 2B shows an exemplary automated substance preparation method according to the present disclosure which can be carried out independently or separate to the automated substance preparation method of FIG. 1A, or alternatively, in addition to the automated substance preparation method of FIG. 1A.

FIG. 3 shows a distribution of sample mass obtained by stochastic sampling and adjustment of a sampling parameter using the automated substance preparation method and system of the present disclosure.

FIGS. 4A and 4B show an exemplary distribution algorithm for sample recombination. FIGS. 4A and 4B show one and the same distribution algorithm for sample recombination, and the schematic process content of FIG. 4A continues onto FIG. 4B, as indicated in the lower left of FIG. 4A and the upper right of FIG. 4B.

FIG. 5 shows steps of an exemplary sample recombination method to generate a list of capsules required for an experiment or operation based on requirements for this experiment or operation and available capsules in an inventory.

FIG. 6 shows steps of an exemplary tool selection method to determine a robotic tool to use in the sampling tool or device.

FIG. 7 shows steps of an exemplary tool sampling method to provide stochastic mass distribution through sampling.

FIG. 8 shows a table showing exemplary tools that may be used to carrying out sampling, tool parameters that can be tuned and applications where these tools are preferrable.

FIG. 9 shows sampling results obtained via sampling carried out by coring with a glass capillaries. Three different powders with different properties were sampled with different capillary size, with each sampling carried out five times.

FIG. 10 shows an image of a sampling device in which the sampling tool comprises a glass capillary and where coring is being carried out.

FIG. 11 shows a sealed capsule sealed by laser sealing and containing powder extracted by coring using the sampling device of FIG. 10.

Herein, identical reference numerals are used, where possible, to designate identical elements that are common to the Figures. Also, the images are simplified for illustration purposes and may not be depicted to scale.

### DETAILED DESCRIPTION OF SEVERAL EMBODIMENTS

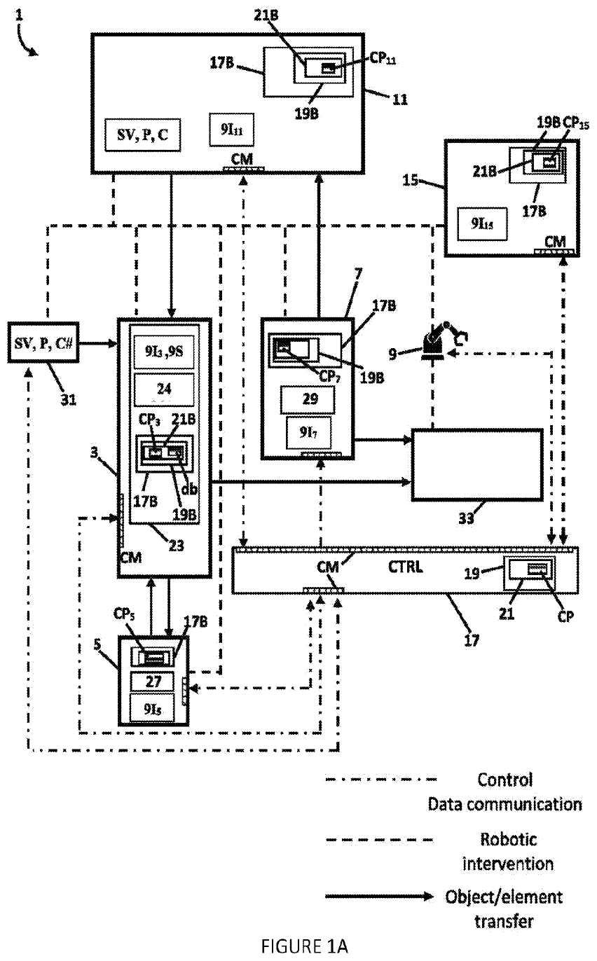

FIGS. 1A and 1B show an exemplary substance preparation system 1, or automated substance preparation system 1 according to the present disclosure.

The system 1 includes, for example, one or more substance containers SV (FIGS. 1A and 1B), at least one sampling system 3, at least one mass determination system 5, at least one substance encapsulating system 7, at least one or a plurality of system robots 9 (for example, articulated system robots 9) configured to carry out object manipulation and displacement, such as manipulation and displacement of the substance containers SV.

Substance containers SV can, for example, be transferred and located at the sampling system 3 and contain a substance 10 that will be sampled and encapsulated in a capsule C.

The system 1 also includes at least one storage area or storage depository 11 configured to store substance capsules C, substance containers SV and plates P. The plates P are configured to hold/support capsules C and substance containers SV. The plate may contain plate location references permitting to attribute a location on the plate to an object held on the plate P, thus permitting a specific object such as a capsule C or substance container SV to be located on the plate when the plate is moved through the system 1 to different elements thereof. The substance containers SV are, for example, retrieved from the storage depository 11 and located at the sampling system 3 by the articulated robot or robots 9.

The system 1 includes, for example, a plurality of substance containers SV with each substance container SV containing, for example, a different substance 10. A plurality of substance containers SV may, for example, contain the same substance 10 with each substance container SV containing a different quantity. The system 1 includes, for example, a plurality of capillaries C#, CL including capillaries C #having different internal hollow tube diameters to allow different quantities of a substance 10 to be collected. The internal hollow tube diameter is such that small substance quantities (for example, mg or μg) can be extracted. The system 1 also includes, for example, a plurality of plates P, with each plate P comprising multiple wells (for example, 96, 384 or 1536 wells). A well is dimensioned so as to be able to receive and hold a capsule, and/or a capillary C#, and/or a substance container SV. The plate p may be, for example, a SBS (society for biomolecular screening) microplate comprising multiple wells (for example, 96, 384 or 1536).

The substance 10 may be a powder or in powder form, or may be a liquid or in liquid form.

The system 1 may also include at least one substance recombination system or platform 15 to which substance capsules C are provided for substance release and for carrying out experiments or substance related operations.

The system 1 includes at least one central controller 17 operatively connected to the articulated robot or robots 9, the sampling system 3, the mass determination system 5, the substance encapsulating system 7, the storage area or storage depository 11, and the recombination system or platform 15. The central controller 17 may also be operatively connected to an entry port or point 31 of the system 1 and an exit port or point 33 of the system 1.

The controller 17 includes at least one communication module CM configured to implement two-way communication between the controller 17 and the system elements, for example, those mentioned above. Communication may be implemented via a wired or wireless infrastructure. The articulated robot or robots 9, the sampling system 3, the mass determination system 5, the substance encapsulating system 7, the storage area or storage depository 11, and the recombination system or platform 15 each also include a communications module CM which is configured to permit communication between each of these system elements, and between each of these system elements and the controller 17.

The system 1 also includes at least one computing means (for example, a microprocessor) 19, and storage means (for example, semiconductor memory, HDD, or flash memory) 21 including one or more computer programs CP. The computer program or programs comprise, for example, program instructions configured, when executed by the at least one computing means 19, to cause the controller 17 to command, operate, synchronize and manage operations of the system 1 and/or the system elements such as the articulated robot or robots 9, the sampling system 3, the mass determination system 5, the substance encapsulating system 7, and for example elements of the storage depository 11, and the recombination system or platform 15.

While FIG. 1A schematically shows the controller 17 as being located as a centrally, it should be noted that the controller 17 may be distributed within the system 1.

The sampling system 3 includes at least one sampling device 23 configured to carry out sampling to extract a portion PN of a substance 10 from one of the substance containers SV. The sampling system 3 may also include or stock capillaries C#that are available to the sampling device 23 to sample the substances 10.

The mass determination system 5 includes mass determination means 27 for determining or permitting to determine a mass of the extracted portion PN of the substance 10. The mass determination means 27 may, for example, comprise a weighting scale or machine.

The substance encapsulating system 7 includes, for example, a sealing device or tool 29 configured to encapsule the portion of substance extracted from a substance container SV in a sealed capsule C.

As mentioned, the system robot or robots 9 may, for example, be an articulated and mobile robot 9 configured to carry out object manipulation and displacement, for example, simultaneously one or more objects, and configured to displace objects from one system element (for example, systems elements 3, 5, 7, 11, 15) to another, and to manipulate the objects at each of the system elements. The robot 9 is configured to transport itself and objects from place to place and from one system element to an another and may be, for example, a wheeled robot.

The computer program CP of the controller 17 includes computer program instructions permitting to control and manage the displacement and object transfer activities of the system robot 9 within the system 1 and between each of the system elements, and permitting to control data and command communication exchanges to and from the robot 9.

The robot or robots 9 assure a robotic transfer system. The robot or robots 9 assure the transfer, between the different parts of the system 1, for example, of the plates, and can be performed by the robots or robots 9 from the beginning of the process until its end. The robot or robots 9 can move source powders and capsules on plates, and interact with the different parts of the system 1 including storage 11, sampling 3, encapsulation 7 and recombination 15 as well as entry and exit points 31, 33.

For example, plates P and/or substance containers SV are displaced from the storage depository 11 to the sampling system 3 and sampling device 23 (and vice versa). Plates P and/or capsules C are displaced from the storage depository 11 to the recombination system or platform 15 (and vice versa). Plates P and/or capsules C are displaced from the substance encapsulating system 7 to the storage depository 11 (and vice versa). Plates P and/or capsules C are displaced from the sampling system 3 to the substance encapsulating system 7 (and vice versa).

Capillaries C#, CL are displaced between the sampling system 3 and the mass determination system 5, and between the sampling system 3 and the substance encapsulating system 7. Capillaries C#can also, for example, be displaced between the mass determination system 5 and the encapsulating system 7.

The system robot or robots 9 are, for example, configured to displace themselves within the system 1 and between different system elements to collect and distribute objects, such as objects held on the plates P. The robot 9 is, for example, configured and programmed to perform autonomously this task or operation. The system controller 17 is, for example, configured to communicate with the robot 9, which for example includes a robot controller comprising a communication module, and the robot 9 is configured to receive command instructions from the system controller 17 that instruct the robot 9 as to the operation or action to be carried out in the system 1. Instructions may, for example, be provided via wireless remote control, for example, via Wi-Fi.

In addition to the robot or robots 9, the individual system elements may include at least one articulated robot 9I configured to carry out object manipulation and displacement and the specific tasks or functions of that element. For example, the sampling system 3 may include at least one robot 9I₃ configured to carry out the sampling activity. The mass determination system 5 may include an individual robot 9I₅ configured to carry out the actions involved in the mass determination activity of the mass determination system 5. Idem, for example, for the substance encapsulating system 7 that includes an individual robot 9I₇ and the storage depository or hotel 11 that includes an individual robot 9I₁₁. The substance recombination system or platform 15 may include an individual robot 91₁₅ configured to carry out the recombination activity alone.

The robot 9I of the individual system elements, is, for example, configured and programmed to perform autonomously tasks or operations associated with that specific system element. The system controller 17 is configured to communicate with the robots 9, 9I which, for example, each include a communication module in a robot controller of each robot 9, 91, and the robots 9, 9I are configured to receive command instructions from the system controller 17 that instruct the robots 9, 9I as to the operation or action to be carried out in the system 1. Instructions may, for example, be provided via wireless remote control, for example, via a Wi-Fi. This permits management of the system operation and activities.

In an alternative embodiment, some individual system elements may include a shared articulated robot 9S configured to carry out object manipulation and displacement and the specific tasks or functions of a plurality of system elements. For example, the sampling system 3 may include a robot 9S configured to carry out the sampling activity, and also actions involved in the mass determination activity of the mass determination system 5, as well as actions involved in substance encapsulating activity of the substance encapsulating system 7. The robot 9S of the individual system element, is, for example, configured and programmed to perform autonomously tasks or operations associated with that specific system element, and specific tasks or functions of the other system elements, for example, those of the mass determination system 5 and the substance encapsulating system 7 in addition to sampling for the shared articulated robot 9S of the sampling system 3. The system controller 17 is configured to communicate with the robot 9S which for example include a communication module in a robot controller, and the robot 9S is configured to receive command instructions from the system controller 17 that instruct the robots 9S as to the operation or action to be carried out in the system 1. Instructions may, for example, be provided via wireless remote control, for example, via a Wi-Fi.

In yet another alternative embodiment, the robot or robots 9 configured to displace themselves within the system 1 and between different system elements to additionally carry out the specific tasks or functions of that element, and the method of the present disclosure. The robot 9 is, for example, configured and programmed to perform autonomously tasks or operations associated with each specific system element. The system controller 17 is configured to communicate with the robot 9, which for example includes a robot controller comprising a communication module, and the robot 9 is configured to receive command instructions from the system controller 17 that instruct the robot 9 as to the operation or action to be carried out in the system 1. Instructions may, for example, be provided via wireless remote control, for example, via a Wi-Fi.

As mentioned previously, the system 1 may also, for example, include the entry port or point 31 configured to take in objects such as plates P, substance containers SV and capillaries C#. The system 1 may also, for example, include the exit port or point 33 configured to remove objects from the system 1 such as waste objects. The system controller 17 may also be configured to control the transfer of objects with the system 1 that are taken in or removed at these ports 31, 33, for example, via the robot 9 or an alternative transfer machine.

The sampling device 23 includes at least one or a plurality of sampling tools or apparatus 24 configured to carry out sampling to extract a portion of a substance 10 from a substance container SV. The sampling tool or apparatus 24 may, for example, comprise or consist of a micro-sampling device or tool configured to extract a portion PN of a substance 10.

The sampling system 3 is the part of the system 1 that samples powders from vials SV and sends or provides them to be encapsulated. The sampling system 3 is configured to select a sampling tool or apparatus 24 for sampling, depending on the powder properties of the powder to be extracted from the substance container SV, and is configured to perform the sampling. The sampling system receives the source vials SV from storage 11, consumables (for example, plates P, capillaries) from the entry point 31 and is configured to choose a sampling tool or apparatus 24 according to the parameters of the powder to be sampled which are, for example, provided to the sampling system 3.

During sampling, the quantity of powder sampled is determined by the weighing part 27 of the mass determination system 5. Once the sampling and weighting are performed, the capillary is sent to the encapsulation part 29 of substance encapsulating system 7 which will create the capsule enclosing the extracted substance. If a source vial SV is empty at the end of the process it is sent to waste in the exit point 33, for example, via robot 9.

The system 1 preferably includes a plurality of sampling tools or apparatus 24. The sampling of powders is as a result adaptive as powders exhibit different physico chemical properties. For this reason, different tools or apparatus 24 are available in the system 1 to adapt to the powder. Some exemplary tools 24 that can be used are described herein but the tools 24 are not limited to these and the sampling system 3 may include additional tools or apparatus 24.

The capillary or capillaries C#to be used by the sampling system 3 may be transferred by the robot 9 (or transferred by the individual robot 9I₃ of the sampling system 3) to the mass determination system 5 to be weighted prior to sampling, and then be transferred by the robot 9 from the mass determination system 5 back to the sampling system 3 for substance sampling.

The tool or apparatus 24 of the sampling device 23 may, for example, comprise or consist of a capillary coring device 24A configured to extract a substance 10 by capillary coring.

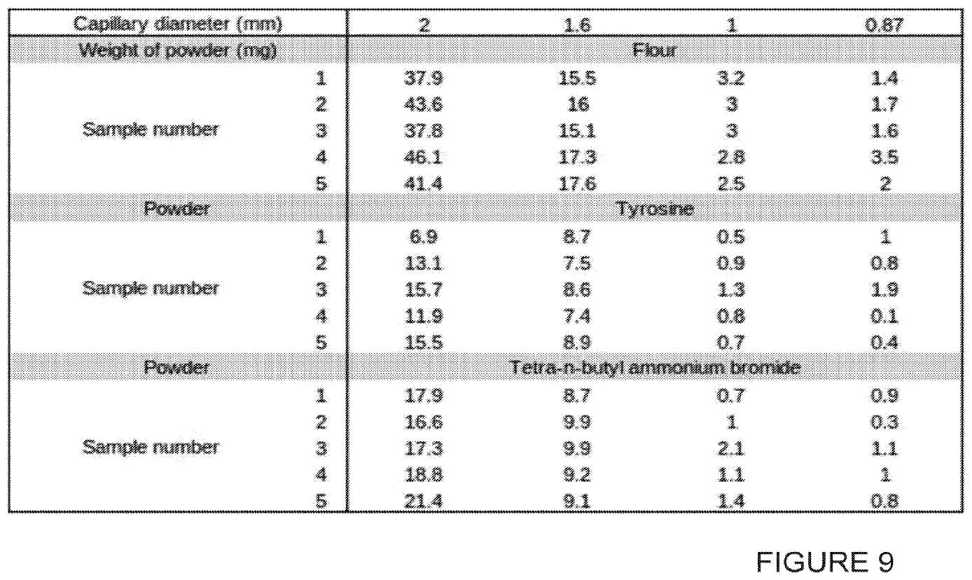

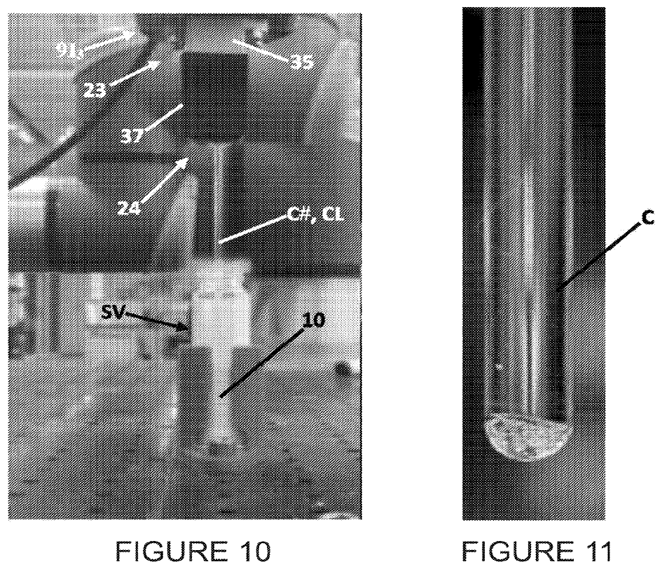

The capillary coring device 24A includes, for example, an end effector or support 37 (see, for example, FIG. 10) configured to hold a capillary C#, CL. The individual robot 9I₃ of the sampling system 3 or sampling device 23 includes, for example, an (articulated) robotic arm 35 (FIG. 10) to which the end effector or support 37 is attached.

The sampling device 23 is configured to command the individual robot 9I₃ and robotic arm 35 to displace the capillary C#, CL to insert the capillary a programmed or configurable distance into the substance 10 contained in a substance container SV (for example, a powder 10 as shown in FIG. 10) to capture a quantity of the substance 10 inside the inner hollow tube of the capillary C#.

The sampling device 23 is configured to displace the robotic arm 35 to remove the capillary with the extracted substance 10 therein from the substance container SV. The capillary may then be transferred by the robot 9 (or transferred by the robot 9I₃ itself) to be weighted at the mass determination system 5. The capillary may then be transferred by the robot 9 to the substance encapsulating system 7 where a sealed capsule C containing the substance is then produced from the capillary C#.

The coring tool 24Ais sampling powder by the sampling device 23 pushing glass capillaries into the powder. The coring tool 24A is able to collect powder in a glass capillary by being pushed inside the powder. Various parameters can be adjusted to vary the amount of powder that is sampled: the diameter of capillary, the height of powder in the source vial SV, the number of punches of the capillary end into or inside the substance. In order to avoid cross-contamination and error in mass, the powder is removed from the outer surface of the capillary. Such operation can be performed using, for example, a self-cleaning substance container or vial SV, using a septum or an O-ring included on the substance container or vial SV. The coring tool 24A can, for example, receive capillaries from the entry point 31 (for example, via robot 9) and receive the powders to be sampled on plates P from the storage hotel or depository 11. Once sampled, the quantity of powder is measured at the weighing part 27 of the mass determination system 5 and the capillary containing the powder sent to the encapsulation part 7 of the system 1.

The powder is sampled using the capillary C# having a narrow inner tube by pushing into the powder. The small amount of powder inside the inner glass tube is compacted therein and can be further handled and confined in a sealed capillary.

The existence of a large range of capillary sizes and inner tube diameters permit to control a mass distribution. Sampling can be carry out using simple robotic movements by the robot 9I₃, and sampling parameters can be easily tuned.

The sampling device 23 may alternatively or additionally include an electrostatic or metallic needle collector 24C configured to collect a substance 10 by electrostatic attachment of the substance 10.

The metallic needle collector 24C includes an end effector or support 37 configured to hold a metallic needle and a voltage or current source, the end effector or support 37 is attached to the robotic arm 35 of the robot 9I₃. The sampling system 3 and sampling device 23 may, for example, include an additional robot 9I₃dedicated to the tool 24C. Alternatively, the same individual robot 913 can be used and replace another tool 24A, 24B.

The metallic needle is attached to the current or voltage source to apply an electric current to the needle to attract and attach powder to the needle when located in a substance container SV. The sampling device 23 is configured to command the robot 9I₃ and robotic arm 35 to displace the needle into the substance container SV, to apply a current or voltage to collect a portion of the powder, and to insert the needle carrying the attached powder into a capillary (for example, held in a plate P or other holder) in which the powder is deposited by removal of the current by the sampling device 23.

The capillary containing the released powder can then be transferred by the robot 9 to be weighted at the mass determination system 5. The capillary may then be transferred by the robot 9 to the substance encapsulating system 7 where a sealed capsule C containing the substance is then produced from the capillary C#.

The electrostatic tool 24C is configured to sample powders using its electromagnetism property. This tool 24C is configured to sample the powder by applying an electric current through a metallic needle. The powder adheres to the needle via electromagnetism and electrostatic forces which allows to manipulate and pick up small amounts of powder. This permits to sample small amounts of powder and transfer the powder into glass capillaries. The capillaries are, for example, sealed at one extremity and provided as such from the entry point 31 of the system 1. The powders to be sampled are for example received on plates P from the storage hotel 11. Once sampled, the mass of the quantity of the powder is measured at the weighing part 27 and the capillary containing the powder is subsequently sent to the encapsulation part 7 for encapsulation.

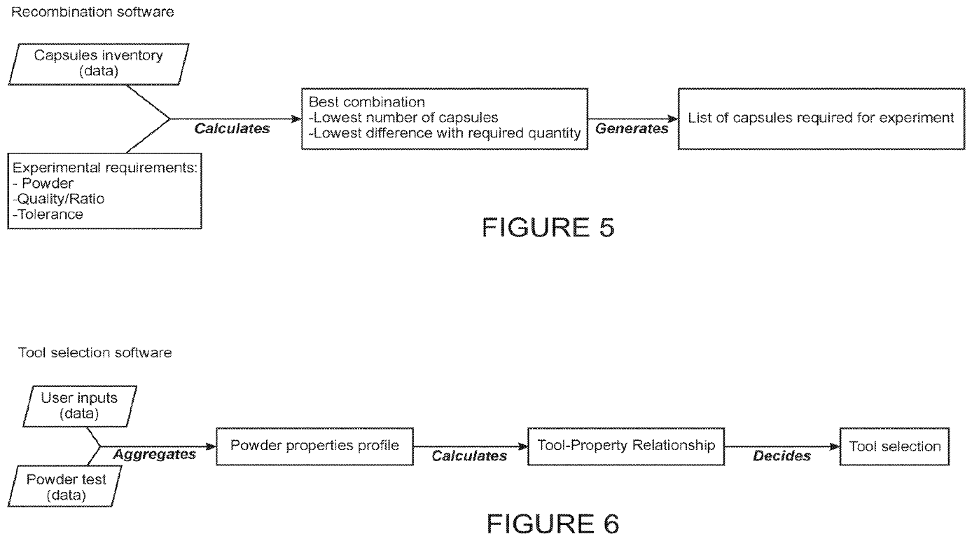

As for example shown in FIG. 8, sampling parameters of these sampling devices 23 may be adjusted to increase a distribution of the extracted mass of a substance 10, and of this substance 10 that is eventually contained in a capsule C.

A sampling parameter of the capillary coring device 23 that can be adjusted is, for example, the diameter of a capillary tube, the number of capillary tube insertion punches into a substance, or a substance quantity that is present in the substance container SV.

A sampling parameter of the electrostatic needle collector 23 that can be adjusted is, for example, an applied electric current amplitude, a needle penetration distance into a substance 10, or an applied current time duration.

The sampling system 3 includes a controller 17B configured to control the sampling system 3 and elements thereof. The controller 17B comprises computing means 19B (for example, a microprocessor), and storage means 21B (for example, semiconductor memory, HDD, or flash memory) including one or more computer programs CP₃. The computer program CP₃ includes computer program instructions permitting to carry out the sampling operation described in the present disclosure. The controller 17B includes at least one communication module configured to implement two-way communication between the controller 17B and other system elements.

The computer program CP₃ also includes computer program instructions permitting to carryout tool selection and includes thus includes tool selection software. These computer program instructions or this software are configured or used to determine which robotic tool 24A, 24B, 24C is used as the sampling tool. As the powders can have different physical properties, their behaviors will be different during the sampling. Because of this, some tools 24A, 24B, 24C will be more adapted to their sampling. The computer program CP₃ or tool selection software includes computer program instructions configured to receive and/or collect user provided information or results from basic tests about the powder properties and configured to determine which tool 24A, 24B, 24C is better suited and to be selected for sampling based on the substance type or identity to be sampled that is provided or received by the controller 17B via the communication module of the sampling system 3.

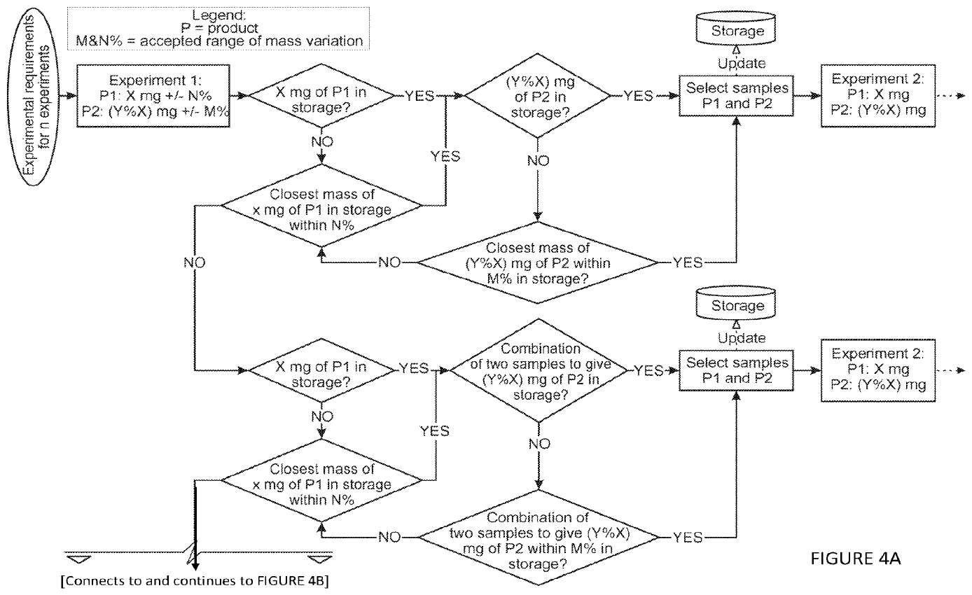

FIG. 6 shows exemplary steps of an exemplary tool selection method to determine a robotic tool 24A, 24B, 24C to use in the sampling device 23 that are implemented by computer program instructions of the computer program CP₃ of the sampling system 3.

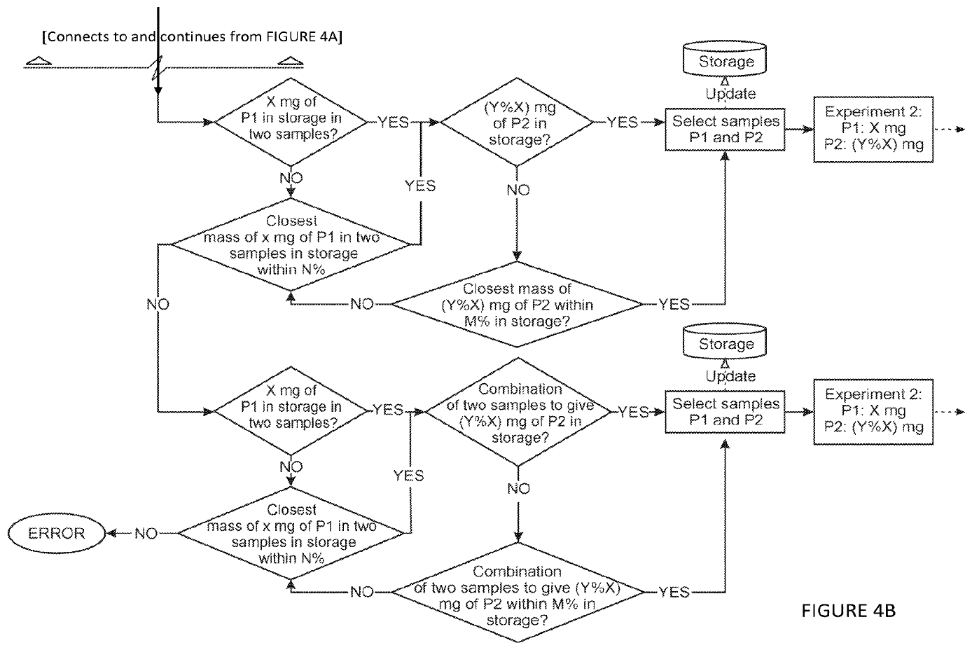

Additionally, FIG. 7 shows exemplary steps of an exemplary tool sampling method to provide stochastic mass distribution through sampling that are implemented by computer program instructions of the computer program CP₃ of the sampling system 3.

The computer program CP₃ also includes computer program instructions permitting to carryout stochastic sampling and includes stochastic sampling software. This computer program instructions or software is configured and used to generate the required sampling instructions to be performed by the sampling system 3 and sampling device 23 when carry out sampling. Each sampling tool 24A, 24B, 24C has parameters that are non-controllable (tolerance, margin of error, amount of powder in source vial . . . ) that will determine a local distribution of the sampling. Each sampling tool 24A, 24B, 24C has also controllable parameters (size of capillary, number of punch . . . ) as mentioned previously that can be modified in order to determine a global distribution of the mass of the substance(s) being sampled. During the creation of a library of capsules C, a mass range is set up or determined (and, for example, provided to the controller 17B of the sampling system 3) in the requirements to determine the distribution of the library. Based on this determined mass range, the computer program CP₃ contains program instructions configured to crate library of capsules C for the one or more substances. The library can be created from the zero or can be refurbished after an experimental run. In the latter, the range will be much smaller. Based on these two inputted information (parameters and requirements), the computer program CP₃ or software is configured determine the value of the sampling parameters to use during the sampling and instruct the sampling device 23 accordingly to perform the sampling based on this determination. The computer program CP₃ or software is also configured to update the library of the storage depository 11 and updates the library so that this feedback will assure adjustment the sampling parameters value at the same time as the library creation by the computer program CP₃ or software.

The mass determination system 5 includes a controller 17B configured to control the mass determination system 5 and elements thereof. The controller 17B comprises computing means 19B (for example, a microprocessor), and storage means 21B (for example, semiconductor memory, HDD, or flash memory) including one or more computer programs CP₅. The computer program CP₅ includes computer program instructions permitting to carry out the mass determination operations disclosed herein and communicate results to other elements of the system 1. The mass determination system 5 is, for example, configured to communicate measured masses to the sampling system 3.

The controller 17B of the sampling system 3 includes at least one database db. The controller 17B is, for example, configured to determine a sampled substance mass of the extracted portion PN based on received capillary masses of a capillary prior to and after sampling, and to register the determined substance mass in the database db along with other information such as substance identity (chemical type) and a storage location or coordinates for the capsule specifying a capsule location (or plate location where the capsule is held on a plate P) where the capsule containing the measured substance mass will be positioned in the storage hotel 11. When the capsule is, for example, stored on a plate P, the storage location of the capsule on the plate is also registered in the database db.

The controller 17B of the sampling system 3 is configured to request, from the controller of the storage depository 11, a storage location or coordinates for the capsule (or plate) at which the capsule will be positioned in the storage hotel 11 and receive such data from the from the controller 17B of the storage depository 11.

This is carried out for every capsule C that is formed and stored in the storage hotel 11. The controller 17B includes, for example, one or more computer programs CP₃ including instructions permitting data communication, mass determination and database registration. The controller 17 is, for example, configured to access the database db.

Alternatively, the database db may be located and maintained by the central controller 17 that is configured to receive mass measurements from the mass determination system 5, and to determine a sampled substance mass of the extracted portion PN from received capillary masses of the capillary prior to and after sampling, and to register the substance mass in the database db (or a centrally stored database in the central controller 17) along with the previously mentioned associated information of formed capsule enclosing the sampled substance.

The database db can, for example, be an ERP (enterprise resource planning) database and operation of the system 1 is implemented based on ERP software implemented by the system controller.

After the precise amount of substance is collected and measured, its mass will be recorded in the database db along with other information such as substance identity (chemical type) and a storage location or coordinates for the capsule specifying a capsule location where the capsule will be positioned in the storage hotel 11. By repeating substance sampling, a large collection of capsules with a large distribution around relevant experimental mass is obtained, and stored in the storage hotel 11 after sealing of the capillaries to form capsules C, with the substance mass, identity (type) and the previously mentioned other information being registered in the database db.

As mentioned, the substance encapsulating system 7 includes the sealing device or tool 29 configured to encapsule the portion PN of substance 10 extracted from a substance container SV in a sealed capsule C.

The sealing device or tool 29 comprises or consists of a laser, for example, a CO₂ laser that may cut and/or seal the capillary to form the capsule. The laser energy can, for example, be applied to the capillary end through which the substance entered to seal a first end of the capillary. The laser energy may then be applied to a second location of the capillary located away from the sealed first end and from the substance contained therein to cut and seal the capillary at this location. Cutting a sealing may, for example, be carried out simultaneously with the laser. The capillary may, for example, be rotated during the cutting and/or sealing action. The encapsulating system 7 includes, for example, the articulated robot 9I₇ configured to carry out manipulation and displacement of the capillary with respect to the laser.

In order to facilitate rupture and opening of the capsule, the laser may be used to engrave or etch a rupture section on the capsule to weaken or fragilize the structure of the capsule at this location. This may, for example, be done by removing material of the capsule at this location (for example, an annular material removal) while still maintaining the air-tight seal of the capsule.

The controlled weakening through laser etching can alternatively be carried out by different etching manners or machining to adjust/reduce the mechanical resistance of the capsule.

The capillary containing the sampled substance may be transferred to the encapsulating system 7 from the mass determination system 5 or the sampling system 3 by the system robot 9.

The substance encapsulating system 7 is used to seal the capillaries into capsules. The laser precisely cuts and seals capillaries, creating an air-tight glass capsule. The substance encapsulating system 7 receives the filled capillaries from, for example, the sampling system 3 and once the capsule is made, it is, for example, placed on a plate P. The localization in the plate storage well is recorded in the database db by the sampling system 3, as well as the mass, substance identity (chemical type) and a storage location or coordinates for the capsule in the storage hotel 11, and the plate is sent to storage hotel 11 via the robot 9. The leftovers from the cut are collected and sent or transported to the exit point 33, for example by the robot 9.

The substance encapsulating system 7 includes a controller 17B configured to control the substance encapsulating system and elements thereof. The controller 17B comprises computing means 19B (for example, a microprocessor), and storage means 21B (for example, semiconductor memory, HDD, or flash memory) including one or more computer programs CP₇. The computer program CP₇ includes computer program instructions permitting to carry out the substance encapsulating and the above mentioned robot 9I₇ operations of the capillaries.

The storage depository or hotel 11 may comprise for example a compartmentalized storage rack or container including a plurality of compartments, where each compartment has a compartment identity or coordinates that can be attributed to a capsule or plate containing capsules stored in the compartment and which is stored in the system database db. Substance containers SV can also be stored in the storage depository or hotel 11, for example, on a plate P.

The storage depository or hotel 11 includes, for example, the articulated robot 9I₁₁ comprising an articulated arm configured to carry out object manipulation and displacement to position objects in compartments of the storage hotel 11 and recover objects (plates, capsules) from these compartments, for example, in view of a provision of capsules to the substance recombination system or platform 15.

The storage depository or hotel 11 includes a controller 17B configured to control the elements of the storage depository or hotel 11. The controller 17B comprises computing means 19B (for example, a microprocessor), and storage means 21B (for example, semiconductor memory, HDD, or flash memory) including one or more computer programs CP₁₁. The computer program CP₁₁ includes computer program instructions permitting to carry out the storage and retrieval operations, and communicate depository retrievals to the controller 17B of the storage system 3, or to the main controller 17 to update the database db, and communicate location data of an attributed storage location following an attribution request from an element of the system 1, for example, the controller 17B of the storage system 3, or from the main controller 17.

The storage depository or hotel 11 is used to store powders and capsules. The powders are stored in source vials SV and in capsules that are, for example, located on plates P. The plates P are stored in the storage hotel that makes use of the robotic arm of the articulated robot 9I₁₁ to pick up capsules or plates required for sampling or experimentation. The location of each vial/capsule/plate is stored in the database db (ERP). The storage area 11 is where source vials SV and capsules on plates are collected from the sampling system 3 and encapsulation system 7. Capsules or plates of capsules are collected from storage in view of given specifications for an experiment or operation at the substance recombination system or platform 15, and transferred to the substance recombination system or platform 15, for example, via system robot 9.

The controller 17 of system 1 is, for example, configured to command and/or control the articulated robot 9 to deposit capsules or plates holding capsules in the storage area 11 where the local articulated robot 9I₁₁ will place the capsules or plates holding capsules in a storage location of the storage area 11 assigned thereto or recorded in the inventory or database db.

In order to have the required samples ready for any kind of experiment, a library of sufficient size should preferably be stored in the storage depository or hotel 11.

The storage depository or hotel 11 can contain or form a capsule library/depository of capsules with distributed substance mass. As mentioned, inventorying in the storage area 11 can be done based on, for example, substance mass, substance identity, location on a plate, and storage location of each capsule and/or plate in a storage area 11.

As mentioned, at the substance recombination system or platform 15, the substance capsules C are provided for substance release and for carrying out experiments or substance related operations. The substance recombination system or platform 15 contains apparatus and vessels for performing an operation or experiment involving mixing of the substances encapsulated in the capsules, or for carrying out a chemical reaction. Also included are for example devices such as a magnetic stirrer motor and a magnetic stirrer permitting to break or open the capsules when placed, for example, in a vessel with the magnetic stirrer. The substance recombination system or platform 15 may also include one or more articulated robot 9I₁₅ comprising an articulated arm configured to carry out object manipulation and displacement to position objects in apparatus and elements of the substance recombination system or platform 15 to permit an operation or experiment involving mixing of the substances encapsulated in the capsules to be carried out.

The recombination system 15 collects and combines capsules required for experimentation When an experiment plan or specification is created, the required capsules are collected from their location in the storage depository or hotel 11 and placed into a new plate P that is sent or transferred to the experimentation location 15. The capsules are collected from storage 11 and transferred, for example, by the system robot 9 to the recombination system 15.

In order to perform an experiment or operation defined by an experiment or operation plan/specification provided to the system 1, for example, to the controller 17B of the recombination system 15, multiple powders are recombined according to specific ratios. The controller 17B of the recombination system 15 includes a recombination computer program or recombination software and is accordingly configured to search across the library, via the system database db, the best combination possible for this purpose. The identified capsules best suited are then retrieved from storage by the robot 9I₁₁ of the storage depository or hotel 11 following instructions provided by the controller 17B. Then subsequent easily measurable liquid reactives and solvent can be automatically adapted to fit the precise combined mass.

Once an experiment or operation is set up or determined, the recombination computer program or recombination software of the controller 17B the recombination system 15 is configured to calculate each individual experiment scale depending on the availability of powders in the storage 11. If different powders are needed in a fixed ratio, it will find the best combination of capsules to reach this target. This can be carried out in association with an experiment preparation computer program or software.

The system includes consumables, for example, plates P, substance containers or source vials SV, capsules C and capillaries C#, C1.

The plates P may, for example, be SBS microplates. They are widely used in life science automation systems and their format is standardized, for example, by the American National Standards Institute by standard ANSI SLAS4-2004 (R2012):
(https://www.slas.org/SLAS/assets/File/public/standards/ANSI_SLAS4-2004WellPositions.pdf).

In the system 1, their external dimensions can be conserved in order to simplify the handling by robotic tools. Their internal configuration can be customized depending on the role they are playing and on the vials or consumables they contain. They can be used to transport consumables or vials containing powders between the different parts of the system 1. They can also be used to store vials or capsules containing powders in the storage 11. The position of the vial on the plate is recorded as its location (for example, as row/column number). They are used, for example, by the robotic tools 9, 9I of the system: transfer, storage, sampling, encapsulation and recombination.

Source vials or substance containers are used, for example, as main containers for the powders coming from the storage 11. During sampling, they contain the source powder or substance. They contain the powders to be sampled and are stored in plates in the storage and used in sampling.

The capsules contain the samples of powder and are stored, ready to be used for an experiment or operation. They are made by the encapsulation or sealing system 7 of the system 1, and are stored in the storage 11 and sent to the recombination system 15 for use in a planned or determined experiment or operation.

The Capillaries are for example glass capillaries and are used, for example, with the coring tool or device 23 to sample powders. The capillaries are used to sample, for example, by punching into the powder in the sampling system 3 and are sealed by laser cutting of the extremities in the encapsulation system 7. Once sealed, they become a sealed airtight capsule. They enter the system 1, for example, via the entry point 31, are used in sampling after their empty weight is set or determined on the weighing part 27 of the mass determination system 5. Once the powder is sampled, the capillary is weighed again in the weighing part 27 and sent or provided to the encapsulation system 7 to be sealed. The leftovers from the capillary cut are collected and sent to the exit point 33 of the system 1.

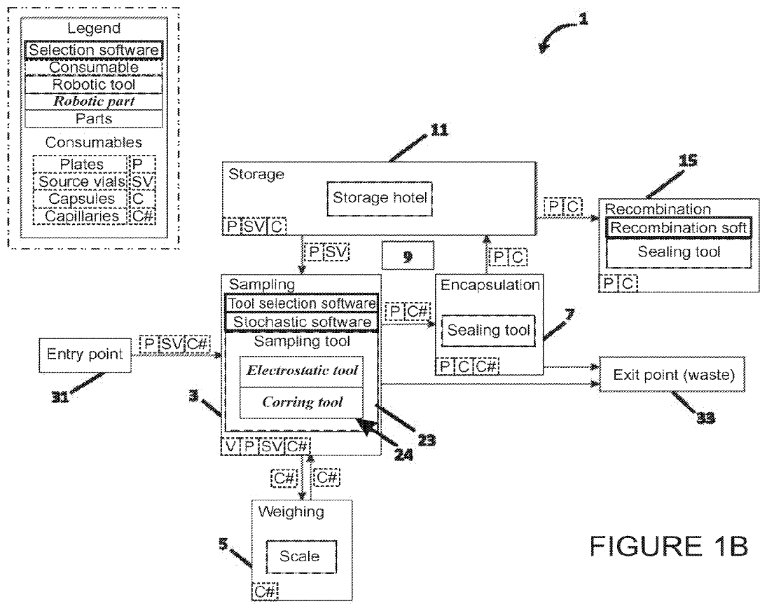

FIG. 2A shows an exemplary substance preparation method or automated substance preparation method according to the present disclosure which can, for example, be carried out using system 1. FIG. 2B also shows an exemplary substance preparation method or automated substance preparation method according to the present disclosure which can, for example, be carried out using system 1. The method and steps of FIG. 2B can be, for example, carried out after the method and steps of FIG. 2A have been performed. The method and steps of FIG. 2B can be, for example, carried out independently to and separate from the method and steps of FIG. 2A.

The methods and processes of the present disclosure concern the automated sampling of small quantities of substances, in particular, powders.

Using micro-sampling techniques, a small quantity of a powder is taken up from a source container SV. This quantity is measured and the sample sealed in a capsule C. By varying sampling parameters, a weight distribution is obtained. All the samples sealed in capsules are stored in storage hotel or depository 11 and inventoried.

During a recombination process, an experiment plan is designed or determined based on criteria or conditions for an envisaged experiment or operation and the available samples in the library of the storage hotel 11 when the powders or substances are required. If ratios of different powders are required, calculation of the optimal combination of capsules is performed. The powders are released from the capsules during the experiment or operation.

Micro-sampling is carried out by sampling small (mg scale or less) amounts of powders and is performed using different automated tools 24 of the system 1. Each different tool 24 can have various parameters that can be tuned depending on the powder properties, and FIG. 8 indicates some exemplary parameters that can be varied.

The powder microsamples is encapsulated in a material that is air tight and inert chemically in order to be stored and handled by the automated system 1. Glass is one preferred choice as it allows encapsulation by melting with a hot source, is inert and resistant enough to be manipulated. Alternatives include ceramic or polymer capsules. Controlled weakening through etching, laser etching or machining can be used to adjust the mechanical resistance of the capsule.

Storage, for example, in storage area 11 of large amounts of samples of various powders in capsules is preferred in order to cover the needs for many experiments or operations.

Depending on the composition of the library in storage depository or hotel 11 and the experimental design (mass, ratios etc . . . ) , an algorithm of the system 1 generates the combination of samples required from the storage 11.

The powders stored in the capsules are released into the experiment by rupture. Pressure increase or mechanical crushing or milling with beads can, for example, be used to rupture the capsules to release the substance or powder contained inside for the experiment or operation being performed.

The process of the present disclosure, consists in not trying to dispense or measure out an exact amount of a specifically targeted mass value. Instead, the powder is sampled without aiming to capture or pick-up a specific target mass, with the powder picked up or the quantity of sampled powder is then precisely and exactly measured. These precisely and exactly measured samples can then be later easily and quickly combined to provide a specifically target mass of the substance or powder for use in an experiment or operation.

Because powders are sampled without aiming at or targeting an exact mass, the collected amounts will be distributed stochastically due to the intrinsic variability of the sampling tools 24. In order to control the distribution of samples weights amongst the desired experimental quantities, the parameters of the sampling tools 24 are varied and can, for example, be controlled by a computer program of the controller of the system, or, for example, by software using learning algorithms.

The creation of the library of samples in storage depository 11 is decoupled from the use of the samples and advantageously allows to parallelize sampling from recombination.

The automated substance preparation method (see, for example, FIG. 2A) comprises providing (S1) a first substance container or source vial SV containing a first substance 10A, and a step (S2) of sampling to extract at least one portion PN of the first substance 10A.

A determination of a mass (S3) of the extracted at least one portion of the first substance is carried out, and then encapsulating (S4), in a first capsule C₁1, of the extracted at least one portion PN of the first substance 10A is performed.

Each of above are repeated, that is, the step of sampling (S2), mass determination (S3) and encapsulating (S4) are repeated to form a plurality of first capsules (C₁1-C₁9) of the first substance having randomly distributed different masses of the first substance 10A.

Repeating the step of sampling (S2), mass determination (S3) and encapsulating (S4) is carried out to form a plurality of first capsules (C₁1-C₁9) having a stochastic mass distribution of the first substance 10A.

The repeating the step of sampling (S2) is, for example, carried out by sampling under the same sampling conditions at that done for the previous or initial sampling (S2), and can be done, for example, from the same first substance container SV.

The plurality of first capsules C₁1 is for example shown to be nine in FIG. 2A but the number of produced capsules is not limited to such quantity. The plurality of first capsules C₁1 may, for example, comprise at least 5, or at least 8 or at least 30 capsules in order to obtain a stochastic mass distribution.

As previously mentioned in relation to the system 1, sampling to extract a portion PN of a substance can, for example, be carried out using the capillary coring device 24A configured to extract a substance 10 by capillary coring, or by the electrostatic needle collector 24C configured to collect a substance by electrostatic attachment of the substance 10.

A sampling parameter associated with substance extraction may be adjusted to increase a distribution of the extracted mass of the first substance 10A and a mass distribution of the first substance 10A contained in the first capsules.

As previously mentioned in relation to the system 1, to increase a distribution of the extracted mass of a substance 10 and of the substance 10 contained in the capsules C, a sampling parameter, of the capillary coring device 24A configured to extract a substance by capillary coring, that can be adjusted is, for example, a diameter of a capillary tube, a number of capillary tube insertion punches into a substance, or a substance quantity in a substance container.

A sampling parameter of the electrostatic needle collector 24C that can be adjusted is an applied electric current amplitude, a needle penetration distance into a substance, or an applied current time duration is adjusted.

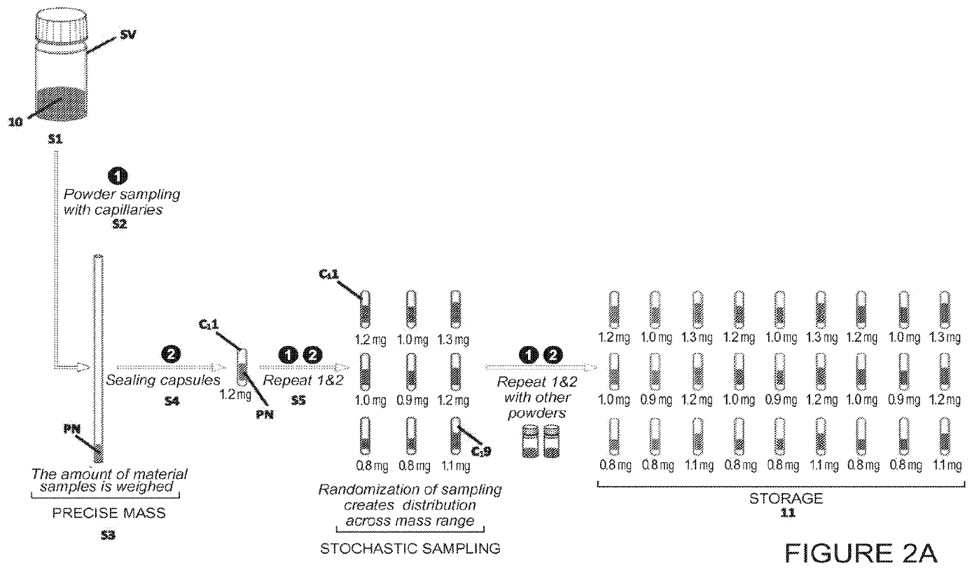

FIG. 3 shows a distribution of sample mass obtained by stochastic sampling and adjustment of a sampling parameter.

The method may further comprise providing such a set (Cₓ1-Cₓ9) of capsules containing a different powder or substance, and providing a plurality of such sets (Cₓ1-Cₓ9). The method may thus further comprise providing a second substance container containing a second substance 10B, carrying out a step of sampling to extract a portion of the second substance 10B, performing a determination of a mass of the extracted portion of the second substance 10B, and encapsulating, in a second capsule (C₂1), the extracted at least one portion of the second substance 10B. Repeating of the step of sampling, mass determination and encapsulating is carried out to form a plurality of second capsules (C₂1-C₂9) of the second substance having randomly distributed different masses of the second substance. The plurality (C₂1-C₂9) of second capsules have a stochastic mass distribution of the second substance 10B.

Similarly, adjusting of the sampling parameter associated with substance extraction may be carried out to increase a distribution of the extracted mass of the second substance 10B and of the second substance contained in the second capsules (C₂1-C₂9).

A plurality of additional capsules of a third substance (and idem for further substances or powders) can similarly be prepared to obtain a plurality of such sets (Cₓ1-Cₓ9), as illustrated schematically in FIG. 1A.

As mentioned previously, a mass of the extracted portion PN of the substance 10 can be determined by measuring or determining a weight, before and after sampling to extract the substance 10, of a capillary used by the sampling tool or device 23. This can be done at the mass determination system 5.

As also mentioned previously, encapsulating of the extracted portion PN of the substance 10 can be carried out by sealing the capillary tube containing the extracted portion PN of the substance, for example at the encapsulation system 7.

A capsule library/depository containing the plurality of capsules of distributed substance mass can be formed in the storage depository or hotel 11. To form the capsule library/depository of capsules, inventorying (for each capsule) can be carried out of the substance mass, substance identity (chemical type) and a storage location (or coordinates) specifying a capsule location (or plate location) at which the capsule containing the measured substance mass is, or will be positioned in the storage hotel 11. Once encapsulated, the capsules can be stored in the storage repository or hotel 11 (for example in plates P) in attributed compartments permitting retrieval of the capsules in a desired combination when an experiment or operation is to be performed in relation to a determined specified mass of one or more substances 10, and a determined specified ratio of substances 10.

FIG. 2B shows an exemplary substance preparation method or automated substance preparation method according to the present disclosure. More specifically, concerns substance recombination using a plurality of the inventoried capsules. This can be carried out in addition to the process of FIG. 2A, but also independently.

When a programed or specified experiment or operation is to be performed, the specification (containing, for example, a detailed description of constituent materials and apparatus required to perform the experiment or operation) of the experiment or operation is used to determine what substances are required for the experiment or operation, in what quantity and in what ratio (S6). Based on this, it is determined, for each substance, the plurality of capsules amongst the stored capsules in storage 11 that are to be retrieved (S7) and that correlate with or correspond to the received or determined substance specifications.

The determined plurality of capsules is retrieved (S8) from the storage depository 11, for example, using the location information stored in the system database db. The local robot of the storage depository is, for example, instructed to carry out such retrieval. The database inventory is modified accordingly to update for the removal of these capsules/plates.

These retrieved capsules are transferred to the recombination system 15 (for example, by system robot 9) where they are used in performing the experiment or operation. The capsules are collected, for example in a vessel, and the substances of the capsules are released by rupture of the capsule to carry out the operation or experiment.

Data relating to each specified experiment or operation and associated generated data can, for example, be collected and stored and thus quickly generates datasets of high quality and quantity that can be exploited by predictive models.

As mentioned previously, the recombination system 15 includes a controller 17B configured to control the recombination system 15 and elements thereof. The controller 17B comprises computing means 19B (for example, a microprocessor), and storage means 21B (for example, semiconductor memory, HDD, or flash memory) including one or more computer programs CP₁₅. The computer program CP₁₅ includes computer program instructions permitting to carry out the recombination operations and experiments described in the present disclosure.

The controller 17B and the computer program CP₁₅ is, for example, configured to receive or determine the substance specifications for the operation or experiment, and the computer program CP₁₅ includes program instructions, which when executed by the computing means 19B cause the computing means 19B to determine, for each substance, the plurality of capsules amongst the stored capsules to be retrieved and that correlate with the received or determined substance specifications.

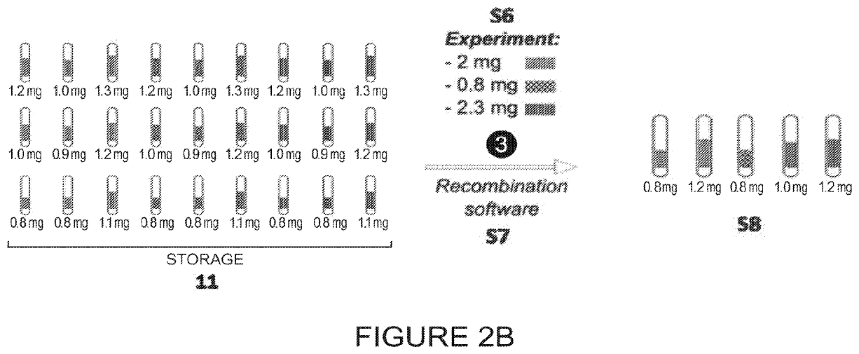

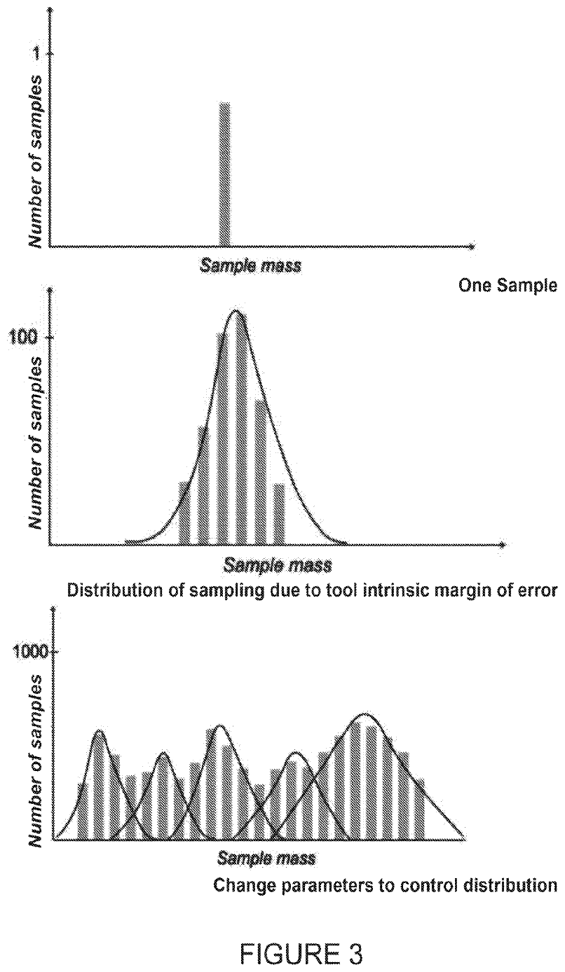

Program instructions for recombination are provided in the computer program CP₁₅, or recombination software is included in the storage means 21B of the system 15 and permits to generate the list of capsules required for an experiment based on the requirements for this experiment and the available capsules in the inventory. FIG. 5 shows the steps implemented by the program instructions for recombination. FIGS. 4A and 4B disclose an exemplary algorithm for sample recombination.

If the inventory does not contain enough capsules, this information is sent back to the sampling system 3 which is configured via the program instructions for stochastic sampling or the stochastic software to program and carry out the fabrication of capsules to increase the library of capsules of the storage depository 11.

The method of the present disclosure procures several advantages, amongst which are speed, quality and standardization.
Speed: The parallelization and the absence of dispensing an exact mass results in a significant gain of time when preparing experiments. A gain of a factor of 8-10 can be expected in the process global process duration.
Quality: Because they are encapsulated, chemicals are less prone to decomposition as they are not exposed to air and moisture. Over time, the same batch is conserved longer. Additionally, if one sample went wrong, only one experiment have biased results.
Standardization: The transfer of any kind of powder for experimental purpose is standardized to the handling of microcapsules, making the process faster, less prone to errors and cross-compatible.

The overall process of the present disclosure provides a great gain of resources for the preparation of an experiment. The sampling can be done ahead or in parallel of the experiments requiring powder. As the solids are encapsulated in standardized glass containers, the robotic dispense of capsules is very efficient, requires no iterative steps, and is not disturbed by the variations of powders properties. It becomes possible to manipulate very small quantities of material (sub mg) efficiently, making this process very advantageous to work with valuable chemicals that can only be accessed in small amounts.

The advantages of encapsulation of powders extends beyond that of just solid dispensing. It enables the efficient manipulation of the chemicals through an automated platform with little footprint. It also protect chemicals from light, oxygen and moisture that are known to accelerate their degradation during storage. It additionally prevents cross contamination during the handling of powders by robots.

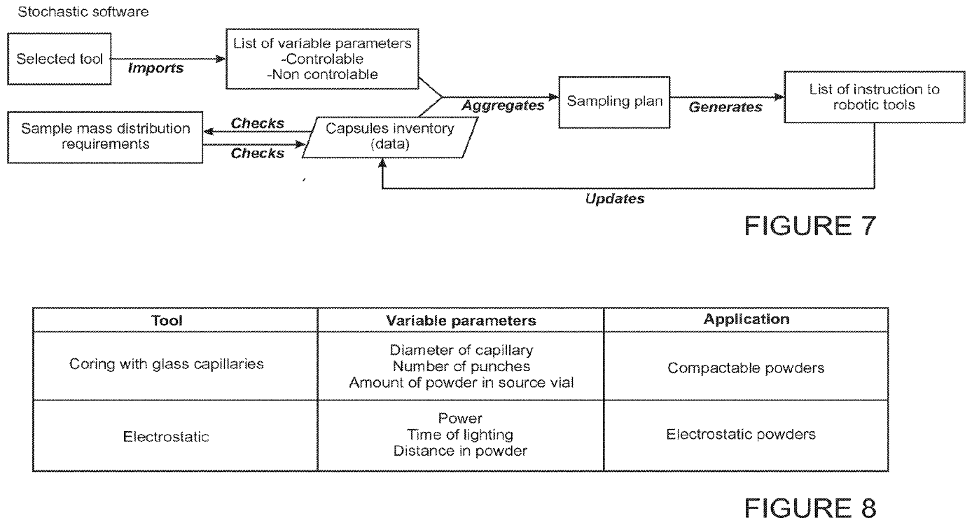

Sampling of powders using capillaries has shown that it is possible to sample with high repeatability sub-milligram quantities of powders. The quantity of powder sampled can be modulated using the diameter of the capillary, the height of powder or the number of push inside the powder. FIG. 9 shows sampling results obtained via sampling carried out by coring with a glass capillaries. Three different powders (flour, tyrosine and NBu₄Br), with different properties (stickiness, granularity, compactability . . . ) were sampled with different capillary size. Each sampling was done five times. Both controlled and non-controlled distribution is observed.

The automated substance preparation system 1 is, for example, also configured to carry out the activities of the above described method.

The system 1 includes computing means 19, and one or more computer programs CP including program instructions, which when executed by the at least one computing means 19 cause the controller 17:
to command or instruct the sampling device 23 to carry out sampling to extract at least one portion PN of the first substance 10A from the first substance container SV;
to command or instruct an articulated robot 9I₅ and the mass determination means 27 of the mass determination system 5 to carry out a mass measurement permitting to determine a mass of the extracted portion PN of the first substance 10A;
to command or instruct an articulated robot 9I₇ and the substance encapsulating means 29 of the substance encapsulating system to encapsulate, in a first capsule C₁1, the extracted portion PN of the first substance 10A; and
to command or instruct the at least one sampling device 23, the mass determination system 27 and associated articulated robot 9I₅, and the substance encapsulating means 29 and associated articulated robot 9I₇ to repeat sampling, mass measurement and encapsulation to form a plurality of first capsules C₁1-C₁X of the first substance 10A having randomly distributed different masses of the substance 10A, or having a stochastic mass distribution of the first substance 10A.

Similarly, a plurality of second, third or further capsules C₁1-C₁X, C₂1-C₂X, C₃1-C₃X, C_{y}l-C_{y}X of the other substances having randomly distributed different masses of the substance, or having a stochastic mass distribution of the substance can be prepared by the automated substance preparation system 1.

The computer program CP may also include program instructions which cause the controller 17 to command or instruct the articulated robot 9I₃ of the sampling device 3 to adjust a sampling parameter associated with substance extraction to increase a distribution of the extracted mass of the substances 10 and a mass distribution of the substances 10 contained in the capsules.

The computer program CP may include program instructions which cause the controller 17 to command or instruct the articulated robot 9I₅ and the mass determination means 27 to measure or determine a mass of the capillary of the sampling tool or device 24 before and after sampling, and command or instruct the sampling system 3 or sampling device 23 to determine a mass of the extracted portion PN from measured capillary masses before and after sampling.

The computer program CP may include program instructions which cause the controller 17 to command or instruct the articulated robot 917 of the substance encapsulating system 7 to seal an inner tube of the capillary containing the extracted portion PN of the substance 10.

The computer program CP may include program instructions, which when executed by the computing means 19 cause the computing means of the main controller 17 or the controller 17B of the sampling system 3 to enter, into the database db, an inventory of the (i) measured substance mass, (ii) substance identity (chemical type) and (iii) a storage location (or coordinates) specifying a capsule location (or plate location) at which the capsule containing the measured substance mass is, or will be positioned in the storage hotel 11. An inventory of all capsules C is created and the database db is updated as capsules C are retrieved or removed from the storage depository 11.

The computer program CP may include program instructions to cause the controller 17 to command and/or control the articulated robot 9 In of the storage depository 11 to deposit the capsule in the allocated storage location of the storage depository 11 that is recorded or will be recorded in the database db.

The computer program CP may also include program instructions, which when executed cause the controller 17 to command or instruct the articulated robot 9 In to retrieve the plurality of capsules amongst the stored capsules that correspond to or correlate with received or determined substance specifications, and to command or instruct the robot 9 of the system 1 to provide the plurality of retrieved capsules to the recombination system 7 to permit release of the substances to carry out an operation or experiment.

Implementations described herein are not intended to limit the scope of the present disclosure but are just provided to illustrate possible realizations.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments and be given the broadest reasonable interpretation in accordance with the language of the appended claims. The features of any one of the above described embodiments may be included in any other embodiment described herein.

1. -42. (canceled)

43. Automated substance preparation method comprising:
providing a first substance container containing a first substance;
a step of sampling to extract at least one portion of the first substance;
determination of a mass of the extracted at least one portion of the first substance;
encapsulating, in a first capsule, the extracted at least one portion of the first substance; and
repeating the step of sampling, mass determination and encapsulating to form a plurality of first capsules of the first substance having randomly distributed different masses of the first substance.

44. Substance preparation method according to claim 43, wherein repeating the step of sampling, mass determination and encapsulating is carried out to form a plurality of first capsules having a stochastic mass distribution of the first substance.

45. Substance preparation method according to claim 43, wherein repeating the step of sampling comprises carrying out sampling under the same sampling conditions of the previous step of sampling, and comprises sampling from the same first substance container.

46. Substance preparation method according to claim 43, further including adjusting at least one sampling parameter associated with substance extraction to increase a distribution of the extracted mass of the first substance and a mass distribution of the first substance contained in the first capsules.

47. Substance preparation method according to claim 43, further comprising:
providing a second substance container containing a second substance;
a step of sampling to extract at least one portion of the second substance;
determination of a mass of the extracted at least one portion of the second substance;
encapsulating, in a second capsule, the extracted at least one portion of the second substance; and
repeating the step of sampling, mass determination and encapsulating to form a plurality of second capsules of the second substance having randomly distributed different masses of the second substance.

48. Substance preparation method according to claim 47, wherein the plurality of second capsules have a stochastic mass distribution of the second substance.

49. Substance preparation method according to claim 43, further comprising forming a plurality of additional capsules of a third or further substance using the step of sampling, mass determination and encapsulating, the plurality of additional capsules having randomly distributed different masses of the third or further substance or a stochastic mass distribution of the third or further substance.

50. Substance preparation method according to claim 43, wherein sampling to extract at least one portion of a substance is carried out using a capillary coring device configured to extract a substance by capillary coring; or an electrostatic needle collector configured to collect a substance by electrostatic attachment of the substance.

51. Substance preparation method according to claim 43, further comprising forming a capsule library or depository in a storage depository, the capsule library or depository containing the plurality of capsules of distributed substance mass.

52. Substance preparation method according to claim 43, wherein the substance preparation method is carried out by an automated substance preparation system, the automated substance preparation system including:
at least one sampling system comprising at least one sampling device configured to carry out sampling to extract at least one portion of a substance from at least one substance container;
at least one mass determination system comprising a first articulated robot and mass determination machine permitting to determine of a mass of the extracted at least one portion of the substance;
at least one encapsulating system comprising a second articulated robot and substance encapsulating device configured to encapsulate, in a capsule, the extracted at least one portion of the substance;
at least one system articulated robot configured to carry out object manipulation and displacement in the system;
at least one controller operatively connected to the at least one system articulated robot, the at least one sampling system, the at least one mass determination system and the at least one substance encapsulating system;
at least one processor, and at least one computer program including program instructions, which when executed by the at least one processor cause the at least one controller:
to command or instruct the sampling device to carry out sampling to extract at least one portion of a first substance from a first substance container;
to command or instruct the first articulated robot and the mass determination machine to carry out a mass measurement permitting to determine a mass of the extracted portion of the first substance;
to command or instruct the second articulated robot and the substance encapsulating device to encapsulate, in a first capsule, the extracted at least one portion of the first substance; and
to command and/or control the at least one sampling device, the mass determination system and first articulated robot, and the substance encapsulating device and the second articulated robot to repeat sampling, mass measurement and encapsulation to form a plurality of first capsules of the first substance having randomly distributed different masses of the substance.

53. An automated substance preparation system including:
at least one sampling system comprising at least one sampling device configured to carry out sampling to extract at least one portion of a substance from at least one substance container;
at least one mass determination system comprising a first articulated robot and a mass determination machine permitting to determine of a mass of the extracted at least one portion of the substance;
at least one encapsulating system comprising a second articulated robot and a substance encapsulating device configured to encapsulate, in a capsule, the extracted at least one portion of the substance;
at least one system articulated robot configured to carry out object manipulation and displacement in the system;
at least one controller operatively connected to the at least one system articulated robot, the at least one sampling system, the at least one mass determination system and the at least one substance encapsulating system;
at least one processor, and at least one computer program including program instructions, which when executed by the at least one processor cause the at least one controller:
to command or instruct the sampling device to carry out sampling to extract at least one portion of a first substance from a first substance container;
to command or instruct the first articulated robot and the mass determination machine to carry out a mass measurement permitting to determine a mass of the extracted portion of the first substance;
to command or instruct the second articulated robot and the substance encapsulating device to encapsulate, in a first capsule, the extracted at least one portion of the first substance; and
to command and/or control the at least one sampling device, the mass determination system and first articulated robot, and the substance encapsulating machine and the second articulated robot to repeat sampling, mass measurement and encapsulation to form a plurality of first capsules of the first substance having randomly distributed different masses of the substance.

54. A substance preparation system according to claim 53, wherein the computer program includes program instructions, which when executed by the at least one processor cause the at least one controller to command or instruct the at least one sampling device, the mass determination system and first articulated robot, and the substance encapsulating device and the second articulated robot to repeat sampling, mass measurement and encapsulation to form a plurality of first capsules of the first substance having a stochastic mass distribution of the first substance.

55. A substance preparation system according to claim 53, wherein the computer program includes program instructions, which when executed by the at least one processor cause the at least one controller to command or instruct the at least one sampling device to adjust at least one sampling parameter associated with substance extraction to increase a distribution of the extracted mass of the first substance and a mass distribution of the first substance contained in the first capsules.

56. A substance preparation system according to claim 53, wherein the computer program includes program instructions, which when executed by the at least one processor cause the at least one controller:
to command or instruct the sampling device to carry out sampling to extract at least one portion of a second substance from a second substance container;
to command or instruct the first articulated robot and the mass determination machine to carry out a mass measurement permitting to determine a mass of the extracted portion of the second substance;
to command or instruct the second articulated robot and the substance encapsulating device to encapsulate, in a second capsule, the extracted at least one portion of the second substance; and
to command and/or control the at least one sampling device, the mass determination system and first articulated robot, and the substance encapsulating machine and the second articulated robot to repeat sampling, mass measurement and encapsulation to form a plurality of second capsules of the second substance having randomly distributed different masses of the substance.

57. A substance preparation system according to claim 53, wherein the computer program includes program instructions, which when executed by the at least one processor cause the at least one controller to command or instruct the at least one sampling device, the mass determination system and first articulated robot, and the substance encapsulating machine and the second articulated robot to repeat sampling, mass measurement and encapsulation to form a plurality of third or additional capsules having randomly distributed different masses of the third or additional substance or a stochastic mass distribution of the third or additional substance.

58. A substance preparation system according to claim 53, wherein the sampling device includes a capillary coring device configured to extract a substance by capillary coring; and an electrostatic needle collector configured to collect a substance by electrostatic attachment of the substance.

59. A substance preparation system according to claim 53, wherein a sampling parameter, of a capillary coring device configured to extract a substance by capillary coring, that is at least one of (i) a diameter of a capillary tube, (ii) a number of capillary tube insertion punches into a substance, and (iii) a substance quantity in a substance container is adjusted to increase a distribution of the extracted mass of a substance and of the substance contained in the capsules.

60. A substance preparation system according to claim 53, wherein a sampling parameter, of an electrostatic needle collector configured to collect a substance by electrostatic attachment of the substance, that is at least one of: (i) an applied electric current amplitude, (ii) a needle penetration distance into a substance, or (iii) an applied current time duration is adjusted to increase a distribution of the extracted mass of a substance and of the substance contained in the capsules.

61. A substance preparation system according to claim 53, wherein the computer program includes program instructions, which when executed by the at least one processor cause the controller or the controller of the sampling system to enter, in an inventory database, the (i) substance mass, (ii) substance identity and (iii) storage area location of the capsule in a storage depository, to form a capsule library/depository of capsules with distributed substance mass.

62. A substance preparation system according to claim 53, further comprising at least one recombination system, and wherein at least one controller of the recombination system includes at least one processor, and at least one computer program including program instructions, which when executed by the at least one processor cause the at least one controller to receive or determine substance specifications for an operation or experiment, and cause the at least one processor to determine, for each substance, the plurality of capsules amongst the stored capsules of the storage depository to be retrieved that correlate with the received or determined substance specifications.
